(19) United States
(12) Patent Application Publication
(10) Pub. No.: US 2007/0153871 A1
(43) Pub. Date: Jul. 5, 2007

(54) Noncontact fever screening system

(76) Inventor: Jacob Fraden, San Diego, CA (US)

Correspondence Address: Jacob Fraden;Ste. 125, 6215 Ferris Sq., San Diego, CA, 92121, US

(21) Appl. No.: 11/636,686

(22) Filed: Dec. 11, 2006

Related U.S. Application Data
(60) Provisional application No. 60/754,996, filed on Dec. 30, 2005.

(51) Int. Cl. G01J 5/00

(52) U.S. Cl. 374/121

(57) ABSTRACT

A system for fast noncontact screening for fever human subjects by means of a thermal imaging camera. The camera is combined with a target gate that incorporates the reference blackbody targets and position detectors to identify the temperature scale and size of a subject. A thermal imaging snapshot is controlled by the position detectors. An afebrile subject produces pixels of a thermal image that fit within the predetermined normal temperature range calibrated by the reference blackbody targets and having no pixels above that range. Exceeding that range by at least two adjacent pixels is an indication of fever that triggers the alarm.

### FIELD OF INVENTION

This invention claims the benefit of a Provisional U.S. Patent Application No. 60/754,996 filed on Dec. 30, 2005. It relates to a medical thermal imaging. More particularly, it relates to devices for the automatic screening of people for fever by means of a thermal imaging device.

### DESCRIPTION OF PRIOR ART

Development of the global mass transportation systems which quickly move people from one country to another increases a risk of spreading infectious diseases, such as SARS (severe acute respiratory syndrome). If not controlled, this may cause a pandemic outbreak. Even a very inefficient transportation system, such as by steamboats, allowed in 1918 a global spreading of viral infection which just within two weeks caused a flu pandemic that took millions of lives. An effective way to limit a risk of pandemic is by preventing the carriers of viral or bacterial infections (infected subjects) to move from place to place and contact other people. This requires a mass screening of people at places of transportation, specifically, at points of entry to a country or city. To be effective, such a screening should be fast, easy to use, and reliable.

Most of dangerous infections, when progressing from the incubation to active phase, manifest in elevated body temperatures (fever). For example, SARS is characterized by fever in excess of 38° C. Body temperature is universally accepted as an important indicator of the physical condition of humans and other warm blooded animals. It is therefore a logical assumption that detection of fever is a reliable means of identifying a sick individual. Since mid of the 19^{th} century the most common method of measuring a body temperature has been insertion of a mercury-in glass thermometer under the armpit or into the patient's mouth or rectum. These traditional thermometers will not register body temperature until after they are left in the body site for several minutes. The closest alternatives are the electronic thermometers that work faster. A more advanced instrumentation was developed for measuring human body temperatures—a non-contact infrared (IR) ear thermometer. While the IR thermometers are non-contact in the scientific sense, practically they all come in physical contact with the human subjects. The only infrared thermometers that do not touch the subject are non-medical optical thermometers having relatively wide angle of view of several degrees or larger and thus not accurate in fever detection. No matter what type of a thermometer is employed for detection of fever, all such thermometers have the following limitations:

1. A physical contact with a human subject (even when the protective covers are employed) may increase risk of spreading infection due to a cross-contamination.

2. A slow speed response—even the fastest thermometers of all (IR ear thermometers, e.g.) which have response times around 1 s, still require handling, the probe cover installation, subject preparation and data registration—totaling to at least 15 s per subject.

3. The infrared thermometers that measure temperature from a distance have poor accuracy due their nature—a poor spatial resolution, so they register an average temperature of the subject that makes fever detection highly inaccurate.

Since the late 1980s, a medical thermal imaging technology has been developed. It is based on taking a thermographic image of a subject in the mid- and far infrared spectral range that is called thermal range. A thermal imaging camera, similar in principle to a photographic camera, registers a digital thermal image in form of many small pixels. A signal magnitude from each pixel directly relates to temperature of a particular object surface area that is represented by such a pixel. The smaller the pixel the better a spatial resolution of the camera. The stronger the signal from a pixel the warmer the corresponding point on the surface of an object or subject. Thinking of a medical IR thermometer it can be said that as opposed to a thermal camera, it has just one very large pixel and thus can register temperature only from a relatively large area of the object. In contrast to an IR thermometer, a thermal imaging camera may have an advantage in detecting fever—it requires very little cooperation from the subject, it's fast in response and requires no physical contact with the subject so a chance of cross-contamination is greatly reduced.

To measure the subject's temperature from a distance, a thermal imaging camera is aimed at the subject's face and a thermal snapshot is taken. Then, temperature of the face is determined by the strength of a signal from a particular facial area, such as a forehead or cheeks. Assuming that the camera is precisely calibrated, the local skin temperature may be accurately computed. If the signal processing is efficient, the internal (core) temperature of the subject can be subsequently computed from the face temperature, and fever, if present, may be detected. Use of a thermal imaging camera while generally attractive due to its numerous advantages, has several limitations, such as a need for the human data interpretation, thermal drifts, low temperature resolution, uncertainty in the subject skin emissivity, strong variations in temperature over the subject's face, effects of the ambient air temperature and many others. These factors reduce effectiveness of the thermal imaging and make its use in the mass fever screening not only expensive, but also inefficient and unreliable. This is the reason why these cameras usually employed with a trained human operator who makes a decision about presence of a fever. It is therefore highly desirable to adapt a thermal imaging technology to the specific needs of fever screening and minimize its drawbacks.

Thus, it is an object of the present invention to minimize effects of thermal drifts on the efficiency of fever detection;

It is another object of the present invention to provide a method of signal processing that minimizes effects of emissivity of the patient skin;

It is another object of the present invention to provide a thermal imaging system doesn't require a precision placement of a subject within the field of view;

It also an object of this invention to select area on the subject's face that is the closest to a core temperature.

Further and additional objects are apparent from the following discussion of the present invention and the preferred embodiment.

### SUMMARY OF THE INVENTION

This patent teaches a design of a system for a fast noncontact detection of fever by means of a thermal imaging camera. The camera is combined with a target gate that incorporates the reference blackbody targets and the position detectors to identify a temperature scale and size of a subject. Taking a thermal imaging snapshot is controlled by the position detectors. An afebrile subject would produce pixels in a thermal image that fit within the predetermined temperature range calibrated by the reference blackbody targets while no warmer pixels should be detected above that range. Exceeding that range by at least two adjacent pixels is an indication of a fever that triggers the alarm.

### BRIEF DESCRIPTION OF DRAWINGS

FIG. 1 shows a plan for setting the test area;

FIG. 2 is a diagrammatic representation of the target gate;

FIG. 3 shows a block diagram of the fever screening system;

FIG. 4 shows a diagrammatic representation of a thermal image;

FIG. 5 illustrates a cross-sectional view of a skin wrinkle, which enhances the emission;

FIG. 6 depicts the pixel magnitudes of a single scan line;

FIG. 7 is a set of the blackbody openings having the circular shapes;

FIG. 8 is a set of the blackbody openings having the triangular shapes;

FIG. 9 is a graphical representation of various temperatures detected by a thermal camera.

### DESCRIPTION OF PREFERRED EMBODIMENT

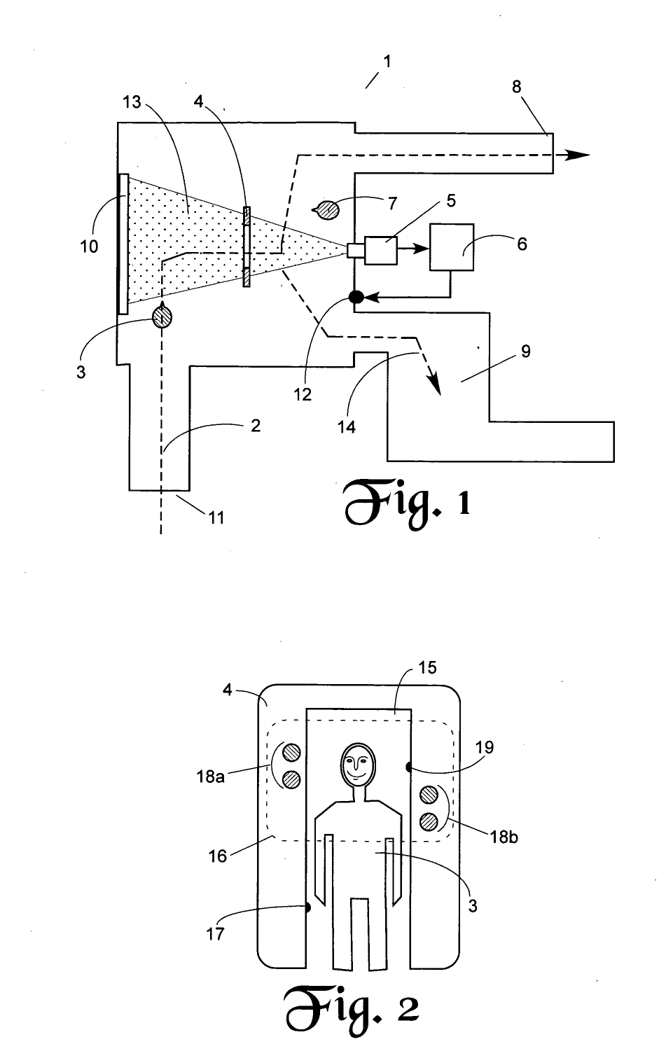

A typical arrangement of the fever screening at a port of entry may be as follows. In an airport, e.g., the test area is situated in a close proximity to an arrival gate. Before exiting from the airport, every passenger and crew member first must pass through the fever screening area 1 whose general layout plan is depicted in FIG. 1. The walking path 2 of a subject 3 leads from the entrance 11 through the target gate 4 and then to the exit 8. The target gate 4 is the place where a fever detection takes place. The detection is performed by the thermal imaging camera 5 and signal processing equipment 6. The equipment 6 is connected to an indicator, for example, an alarm 12 which is activated when fever is detected. The screening operator 7 supervises the procedure and directs the subject 3 either to exit 8 or to the secondary screening section 9 where the selected subjects who triggered the alarm 12, undergo the secondary testing with a conventional clinical thermometer. If fever is confirmed, the febrile subject is processed by a medical personnel.

The following factors and conditions should be considered when setting up a fever testing system:
1. The testing area and the adjacent entry room (not shown in FIG. 1) should be air conditioned with the ambient temperature set preferably in the range from 20 to 22° C.
2. Subjects should remain in the air conditioned entry room for at least 2-3 minutes before proceeding along path 2.
3. When passing through the target gate 4, subject 3 should stop within the gate clearance for at least 1 second for a thermal image to be taken by the camera 5.
4. While within the target gate 4, the subject 3 should keep his (her) face open and the eyeglasses, if any, must be removed.
5. When stopping within the target gate 4, the subject 3 should look straight to the camera 5 and not turning the face sideways.

When the subject 3 passes through the target gate 4, camera 5 is activated to take a thermal snap shot. FIG. 2 illustrates an external view of the target gate 4 having clearance 15 through which subject 3 must pass through before exiting. The moment of passage is detected by a conventional presence detector 17, for example, by breaking a beam of light. As soon the detector 17 generates a signal, thermal imaging camera 5 (not shown in FIG. 1) takes a thermal picture (a snapshot). The thermal image is limited by the camera's field of view indicated by a broken line 16. If the subject is short in height—a child, e.g., his face may be outside of the filed of view 16. To force the camera 5 to reposition the filed of view (either manually or automatically), a secondary presence detector 19 may be employed. It is installed higher than detector 17, so for a tall subject, both detectors will respond, while for a shorter one, only the lower detector 17 will generate a signal. Naturally, more than two such detectors may be employed to accommodate for a finer adjustment of the field of view positioning. Alternatively, the height of the subject may be determined by a pattern recognition of the image taken by camera 5 and the camera field of view adjusted accordingly. This however would require a camera with the increased spatial resolution (more pixels). Another alternative way of positioning a thermal imaging camera is to supplement it with a conventional visible range video camera with an appropriate pattern recognition system (these components are not shown in the figures). Such auxiliary equipment, while effective for a correct thermal image acquisition, does not directly relate to the main subject of this invention and thus is not described here.

The target gate 4 may incorporate some kind of an automatic door (not shown) to allow the subject 3 to continue walking after a thermal snapshot is taken. Also, the target gate may support one or more of the thermal reference targets 18a and 18b that generates the calibrated IR signals.

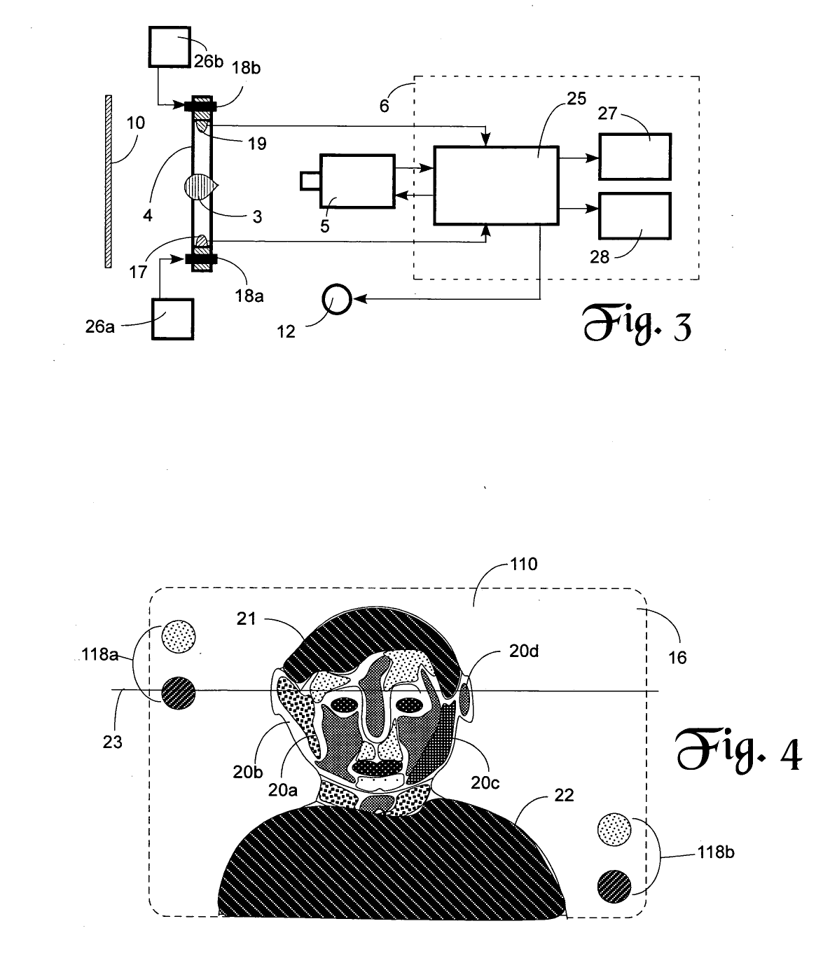

A block diagram of the system is shown in FIG. 3. It includes the background panel 10 positioned behind the target gate 4. The panel 10 is fabricated of a material having relatively high emissivity in the mid and far infrared (IR) spectral range, that is 0.95 or higher. An example is a cloth made of thick polymer fibers. A surface of the panel 10 will be approximately at the ambient air temperature Tₐ. The panel 10 is visible through the gate 4 by a thermal imaging camera 5. Camera 5 may be of a conventional design, such as with a cryogenically cooled photoresistive sensor or a room temperature camera with a micro bolometer sensor. Preferably, the camera should have a resolution of 300 pixels or better. The camera is connected to the processing equipment 6 that is indicated by a broken line. The processing equipment incorporates the computational means 25 that, in turn, is connected to a recorder 27 and indicator 28. Recorder 27 is used for storing data of a thermal scanning and indicator 28 displays the current temperature of the subject. The computational means 25 may incorporate a threshold generator and a comparator (not shown in FIG. 3). Alarm 12 is also controlled by the computational means 25. The reference target sets 18a and 18b are installed into the gate 4 and are controlled by the respective controllers 26a and 26b. The presence detectors 17 and 19 are connected to the computational means 25 that actuates the camera 5 for taking a snapshot thermal image of the subject 3 when the subject is present in the clearance of the gate 4.

FIG. 4 illustrates an example of a thermal snapshot within the filed of view 16. The subject's face and torso is represented by a pattern having different levels of brightness, related to various degrees of the IR signal emanated from the surface. Each facial area 20(a, b, c and d) is formed by numerous pixels of the pattern and thus represents a specific strength of the signal from these pixels (sown by various shadings in FIG. 4). Note that each specific area of a thermal image may consist of various numbers of pixels from as little as 1. The strength of the IR signal in each pixel depends on at least two major factors: 1) the surface temperature of that particular area of the subject, and 2) the surface emissivity of that particular area of the subject.

Besides a thermal image of the subject, the filed of view 16 contains also the pixels 110 corresponding to the background panel 10, pixels 118a and 118b, corresponding respectively to the reference targets 18a and 18b, respectively.

A surface temperature of any subject or object depends on several factors: the internally generated heat, the surface finish, material, mechanical and thermal properties, ambient air temperature, ambient air convection, nearby heat sources and other factors. If the subject is a human face, temperature is influenced by the skin vascularization, proximity to the arteries, recent food digestion, recent imbibing, medications, emotional state, core body temperature, clothing, and ambient conditions. The human skin emissivity in the mid and far IR spectral range varies from 0.93 to 0.99 and may be affected by such factors as anatomical differences, skin conditions, wrinkles, applied makeup, sweating, etc.

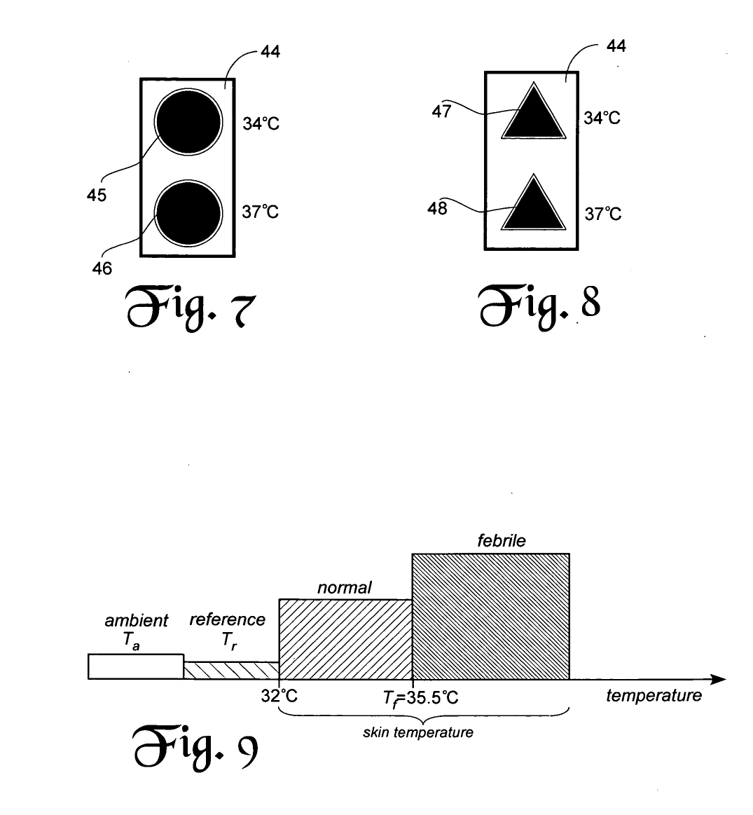

To relate the skin temperature from a thermal image to a temperature scale, it is essential to accurately calibrate camera 5. That is, the signal strength from each pixel must have a metrologically accurate relationship to an absolute temperature. Unfortunately, all modern thermal imaging cameras are prone to drifts even within a short period. Frequent recalibrations would be highly impractical. Thus, to establish an accurate relationship between the subject thermal pattern and the absolute temperature scale, one or better two IR reference targets 18a and 18b should be present within the filed of view 16 of each snapshot. A reference target is a source of a thermal (IR) radiation signal having properties of a blackbody with a precisely known temperature. Emissivity of such a reference target shall be near 0.990 and preferably as close to 1.000 as possible. FIG. 4 shows two images 118a and 118b of the reference targets within the field of view 16, however just one set may be sufficient in most applications. A second (and possibly the third) set may be useful when the field of view is repositioned to accommodate subjects of various heights. Physically, these reference targets may be mounted on the target gate 4 as shown in FIG. 2. Each set consists of one or two blackbody targets 44 (FIGS. 7 and 8) having different temperatures selected within the human face temperature range, which generally is from 30 to 40° C. Preferably, the target blackbodies within each set should have temperatures 34 and 37° C. (targets 45, 47 and 46, 48, respectively). An efficient way of fabricating a blackbody target is taught by the U.S. Pat. No. 6,447,160 issued to J. Fraden and thus is not described here in detail. For the practical purposes, the blackbody opening should have a specific shape and size for a better pattern recognition or identification by the processing equipment 6. For example, the blackbody openings 45 and 46 may be circular (the set of FIG. 7) or triangular, 47 and 48 (the set of FIG. 8) and have the overall size typically between 2 and 5 cm.

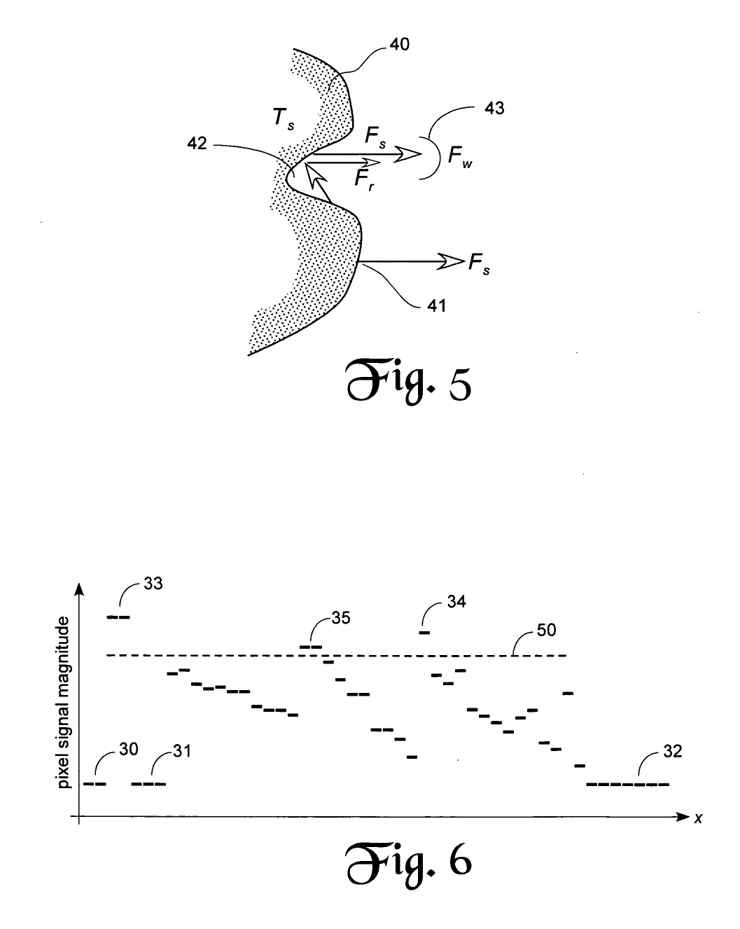

As shown in FIG. 4, the snapshot contains various levels of the signals, depending on the camera 5 resolution and sensitivity. A skin emissivity that varies from person to person and even within a person will affect accuracy of the skin temperature computation. This dependence, however is mostly pronounced for the emission from a flat portions of the skin. Fortunately, variations in shape of a human face, such as wrinkles, impressions around nostrils, eye sockets and other similar areas produce the so called cavity effect that will enhance the skin emissivity to a higher level, close to 0.99 or even higher, regardless of the skin surface flat surface emissivity, sweat, makeup, etc. The cavity effect is described in detail in book by Jacob Fraden “Handbook of Modern Sensors”, 3^{rd} ed., Springer-Verlag, N.Y., 2004. FIG. 5 illustrates how the cavity effect enhances the surface emission. A flat surface 41 having temperature Tₛ emanates an omni-directional thermal IR flux Fₛ. Within a wrinkle 42, e.g., the same flux magnitude is emanated outwardly in all directions, including the wrinkle's inner wall, which reflects the flux Fᵣ to the outward direction. Thus, a combined emission 43 from the wrinkle 42 contains two fluxes: Fₛ and Fᵣ making a combined flux F_{w} stronger. The cavity effect enhances the wrinkle emissivity close to a unity, regardless of the flat skin 41 emissivity. This makes the wrinkles and other impressions on a human face appear in a thermal image somewhat warmer than the flat skin.

To take an advantage of the cavity effect, according to this invention, the camera 5 and the processing equipments 6 should not have or use a skin emissivity correction. It should assume that the subject's emissivity is 1. The skin temperature should be computed only from the specific portions of a human face where the cavity effect is pronounced: the wrinkles, facial impressions (like near the eye sockets), etc. Emission from these areas is the highest at the same temperature.

To compute the skin temperature and subsequently estimate the core temperature, the pixels with the highest IR emission should be selected. As a rule, this level will correspond to the highest (cavity effect enhanced) skin emissivity at the warmest areas of the face. FIG. 6 illustrates a single line of a scan (indicated as line 23 in FIG. 4). A height of each small segment represents the IR signal strength of a pixel. Note that pixels 30, 31, and 32 correspond to the thermal image area of the emission from the background panel 10, pixels 33 correspond to the reference target having temperature 37° C., while the rest of the pixels are for the subject's face and clothing. To find the warmest spot on the face, pixels 35 are selected, even though a pixel 34 is somewhat higher. The reason for selecting pixels 35 is that the pixel 34 is single in this scan and no such warm pixels are in the adjacent scans either. All directly adjacent pixels in this and other scans are cooler. A single “hot” pixel may be caused by noise, e.g., so for the improved reliability, the highest thermal level should be detected from the several adjacent pixels, at least two and preferably more, depending on the camera resolution and size of an image. Typically, a healthy person has smaller areas of the warmest pixels, while fever makes the skin temperature more thermally homogeneous and the clusters of the “hot” pixels increase in size. All these factors can be used in the signal processing software to improve reliability of screening.

It should be noted that in the simplest embodiment of the system, no skin temperature computations need to be performed. A threshold comparison can be made directly with the IR signal magnitudes of the pixels. In other words, a fever threshold can be generated as a pre-determined value of an IR flux level as illustrated by the line 50 in FIG. 6. To minimize effects of the thermal drifts in the imaging camera, the threshold level 50 should be adjusted by the emission from the reference targets (pixels 33). For even better accuracy, the threshold value can be also adjusted by the position of the background (ambient) flux pixels 30, 31 and 32. The lower the background pixels, the lower the threshold 50. If pixels 35 are higher than the threshold 50, the fever is present.

A still better accuracy of the fever detection would require a temperature computation. The skin temperature is computed from the signal magnitude of the selected pixels 35 (the warmest). The computation must account for the reference target pixels 33 to adjust the scale. Alternatively, the reference target IR signal may be used to adjust the fever threshold (T_{F}—see below). The temperature computation uses an inverted equation for the Stefan-Boltzmann law that is well known in art of thermal imaging and thus is not described here in detail.

After the skin temperature Tₛ is computed, it can be directly used for the fever detection. However, the fever threshold T_{F} for the skin is different from that of the body core. At normal ambient conditions, the skin is always cooler. A typical fever core threshold is 38.0° C., while the fever skin threshold is near 35.5° C. (at room temperature near 22° C.). The detection of fever is performed by the computational means 25 by using one of three thresholds, depending on the selected method of detection: directly from the IR signal level, from the skin temperature, or from the core temperature.

There are several ways for improving accuracy of the detection. One is to adjust the skin fever threshold by the ambient temperature Tₐ. This temperature can be computed from the signal magnitude of the background panel 10 (pixels 30, 31 and 32 in FIG. 6). Another way of improving accuracy, is by first computing the body core temperature T_{c} and then by using a core fever threshold.

To compute a core temperature from the temperature of a selected skin area, the following equation may be employed:

T_{c}=ATₛ²+(B+CTᵣ)Tₛ+DTᵣ+E (1)

where A, B, C, D and E are the experimentally determined constants whose values depend on the temperature scale. For example, the factor C typically is between 0.1 and 0.3 if T is in Celsius. The value of Tᵣ is a reference temperature that maybe the ambient temperature Tₐ measured from the panel 10. Alternatively Tᵣ can be computed from the lowest pixels corresponding to the subject's clothing which has “memory” of the exposure to the outside ambient conditions (before entering the screening area). This may be important when the subject walks into the screening area from either a hot or cold environment.

To enhance reliability of computation of the skin and subsequently core temperature and the fever detection, the signal processing software should make use of the following temperature levels.
1. THₛ is the lowest normal skin temperature that can be detected. Typically it is near 32° C. This pres-set level is for determining if a human face is fully exposed to the camera 5. If no pixels present above THₛ, this means that no skin temperature can be computed and the subject must be either re-screened or moved for the manual testing by a conventional clinical thermometer. A possible cause for that may be a covered face (kerchief, veil, hairs, etc.) or the intentional deception (bowing or turning the face away).
2. T_{F} is the fever threshold. For the skin, typical T_{F}=35.5° C. while for the core T_{F}=38° C.
3. The reference level THᵣ is typically +5° C. It is used for a correct computation of a core temperature as described below.

Note that the above temperatures and the action of a comparison with the thresholds (by a “comparator”) may be implemented either in a hardware or in a software, depending on the actual system design. In any event, a threshold generator produces a value equal to a fever threshold and the comparator makes a comparison to detect fever.

The relationship between various temperatures for the skin detection is shown in FIG. 9.

The reference temperature Tᵣ may be warmer or cooler than the ambient air temperature Tₐ. If in the thermal image contains pixels “colder” than Tₐ, the “coldest” pixels should be used for computation of Tᵣ. If there are no pixels cooler than Tₐ, the “warmest” pixel within the relatively narrow range from Tₐ and Tₐ+THᵣ should be used for computation of Tᵣ. For example, if Tₐ=21° C., and the coldest detected pixels correspond to 17° C., then Tᵣ=17° C. If all pixels are above Tₐ=21° C., then check if there are any pixels below 26° C. (Tₐ+THᵣ=21+5° C.=26° C.) and the warmest of these correspond to Tᵣ. Use the computed Tᵣ in Eq. (1) to compute the core temperature before using the fever threshold T_{F}. This method allows for accounting for the cold and hot environments from which the subject walked in to the test area.

The invention has been described in connection with preferred embodiments, but the invention is greater than and not intended to be limited to the particular forms set forth. The invention is intended to cover such alternatives, modifications, and equivalents as may be included within the spirit and scope of the invention.

1. A noncontact fever detection system for determining presence of the elevated body temperature in a human subject, comprising
a thermal imaging camera,
a signal processing equipment,
a fever threshold generator,
a signal comparator, and
an indicator.

2. A noncontact fever detection system of claim 1 further comprising a target gate positioned in the field of view of said thermal imaging camera.

3. A target gate of claim 2 comprising at least one source of a reference thermal radiation signal having a preset level of thermal radiation.

4. A noncontact fever detection system of claim 1 wherein said fever threshold generator generates a threshold in relation to ambient temperature.

5. A noncontact fever detection system of claim 1 further comprising a position detector for detecting presence of a human subject within a field of vies of said thermal imaging camera.

6. A method of noncontact detection a fever in a human subject comprising of steps:
exposing a human subject to a thermal imaging camera,
taking a thermal snapshot by a thermal imaging camera,
processing a thermal image to determine the maximum level of thermal radiation from a face of a human subject.

7. A method of claim 6 further comprising a comparison of the maximum level of a thermal radiation with a pre-selected threshold value.

8. A method of claim 6 further comprising comparing indicating fever if the level of a thermal radiation exceeds the threshold value.

9. A method of claim 6 further comprising a step of positioning a human subject within the opening of a target gate.

10. A method of claim 6 further comprising a step of generating an infrared signal by a reference target positioned within the field of view of said thermal imaging camera.

11. A method of claim 6 further comprising a computation of a skin temperature of a human subject as function of the maximum level of thermal radiation.

12. A method of noncontact detection a fever of claim 6 comprising a step computation of a core temperature of a human subject including an adjusting of the maximum level of thermal radiation by the value of a reference temperature.

13. A method of noncontact detection a fever of claim 12 where a reference temperature is an ambient temperature.

14. A method of noncontact detection a fever of claim 12 where a reference temperature is a temperature computed from a thermal radiation detected by an imaging camera from clothing of said human subject.

15. A method of noncontact detection a fever of claim 7 comprising a step of exposing the infrared camera to a reference target and adjusting the pre-selected threshold by the infrared signal from a reference target.

16. A method of claim 6 further comprising a step taking a picture of a human subject by a video camera operating substantially in a visible spectral range and adjusting the position of said thermal imaging camera to position its filed of view over the human subject.
